(19) United States
(12) Patent Application Publication
(10) Pub. No.: US 2025/0119818 A1
(43) Pub. Date: Apr. 10, 2025

(54) METHOD FOR UPDATING AN ACCESS POLICY FOR A FIRST TELECOMMUNICATIONS NETWORK, AND CORRESPONDING SYSTEM, DEVICES AND COMPUTER PROGRAMS

(71) Applicant: Orange, Issy-Les-Moulineaux (FR)

(72) Inventors: Gaël FROMENTOUX, Chatillon Cedex (FR); Emile STEPHAN, Chatillon Cedex (FR); Frédéric FIEAU, Chatillon Cedex (FR)

(21) Appl. No.: 18/729,874

(22) PCT Filed: Jan. 12, 2023
(86) PCT No.: PCT/EP2023/050582

§ 371 Date: Jul. 17, 2024

(30) Foreign Application Priority Data
Jan. 18, 2022 (FR) FR2200402

(51) Int. Cl. H04W 48/06; H04W 40/24

(52) U.S. Cl. CPC H04W 48/06; H04W 40/248

(57) ABSTRACT

The field of the system and method is that of updating, within a first telecommunication network, access policies to a second telecommunication network. Edge computing thus minimises bandwidth requirements between devices and data processing centres. Generally, the access policy depends on the access rights negotiated between the operator of a communication network MNO and the operator of the communication network MEC (edge computing). However, these policies are most often static and do not allow for flexible management of the changing needs of the parties concerned. By establishing direct communication between a device in a communication network MEC and a device in a communication network MNO, the system and method enables the implementation of a more flexible and dynamic procedure for updating the access policy to the communication network MEC.

### CROSS-REFERENCE TO RELATED APPLICATIONS

This application is filed under 35 U.S.C. § 371 as the U.S. National Phase of Application No. PCT/EP2023/050582 entitled “METHOD FOR UPDATING AN ACCESS POLICY A FOR FIRST TELECOMMUNICATIONS NETWORK, AND CORRESPONDING SYSTEM, DEVICES AND COMPUTER PROGRAMS” and filed Jan. 12, 2023, and which claims priority to FR 2200402 filed Jan. 18, 2022, each of which is incorporated by reference in its entirety.

### BACKGROUND

### Field

The field of the development is that of updating, within devices of a first telecommunication network, policies for accessing a second telecommunication network. Within the context of the present development, the term “access policy” to the second network means an access policy to the resources of this second network by one or more devices belonging to the first network.

More precisely, the development relates to a solution for updating, within devices belonging to a telecommunication network operated by a telecommunication operator such as a radio communication network, access policies for services or applications deployed in an “edge computing” environment.

### Description of the Related Technology

A new phase in the development of “cloud computing” has emerged in the last few years. This new development is known as “edge computing” and involves processing data at the edge of the network, as close as possible to the source of the data.

“Edge computing” minimises bandwidth requirements between equipment, such as sensors, and data processing centres by undertaking the analysis as close as possible to the data sources. This approach requires the mobilisation of resources that may not be permanently connected to a network, such as laptops, smartphones, tablets or sensors. “Edge computing” also plays a key role in content ingestion and delivery solutions.

FIG. 1 shows in a simplified manner a system comprising a radio communication network interacting with an architecture of the “edge computing” type.

A radio communication network MNO operated by a telecommunication operator comprises a plurality of devices 10-13 such as servers implementing various functions relating to the attachment and connectivity of user devices UE exchanging data via the infrastructures of the radio communication network MNO. In the example described, the radio communication network MNO complies with fifth generation or 5G telecommunications standards.

In the example described, a first device 10 implements a Network Exposure Function (NEF), a second device 11 implements a Policy Control Function (PCF), a third device 12 implements a Session Management Function (SMF) and finally a fourth device 13 implements a User Plane Function (UPF).

This radio communication network MNO interacts with a second communication network MEC (Multi-access Edge Computing) implemented in the form of an “edge computing” architecture.

Such a communication network MEC comprises a plurality of devices 20-22 such as servers implementing various functions enabling user devices UE exchanging data via the infrastructures of the radio communication network MNO to access services and/or applications hosted in the communication network MEC.

In the example described, a first device 20 implements a function for orchestrating the communication network MEC, a second device 21 implements a data routing function or UPF (User Plane Function) and a third device 22 is a server for accessing a service and/or an application.

In such a system, the routing of the streams conforming to the PDP (Packet Data Protocol) within the communication network MNO is carried out according to the access policy defined by the operator of the communication network MNO.

The parameters allowing the implementation of this access policy are transmitted by the device 12 implementing the SMF function to the device 13 implementing the UPF function, which implements this access policy according to the parameters received. The device 12 has itself received information about the access policy to be implemented from the device 11 implementing the PCF function.

Generally, the access policy depends on the access rights negotiated by each user of a user device UE with the operator of the communication network MNO, on the policies negotiated between the operator of the communication network MNO and its partners, such as the operator of the communication network MEC, and is based on connectivity information such as, for example, the quality of service QoS offered, the availability of certain slices of the network, etc.

The policies negotiated between the operator of the communication network MNO and the operator of the communication network MEC define the conditions for redirecting streams from a user device UE attached to the radio communication network MNO to the communication network MEC and the device 21 which may (or may not) implement a UPF function specific to the radio communication network MEC.

However, these LBO policies negotiated between the operator of the communication network MNO and the operator of the communication network MEC are most often static and do not allow flexible management of the changing needs of the various parties involved.

There is therefore a need to offer a solution enabling operational management—deployment, configuration, updating, hosting of content and applications—of such a radio communication network MEC that does not have some or all of these disadvantages.

### SUMMARY

The development addresses this need by proposing a system comprising at least one first device belonging to said first telecommunication network and at least one second device belonging to a second telecommunication network, wherein said first device comprises at least one processor configured to:
generate at least one set of parameters for updating the access policy to said first network, initiated by obtaining information relating to a modification to said access policy,
transmit said set of parameters for updating the access policy to said first network to said second device,
   and wherein said second device comprises at least one processor configured to:
receive said set of parameters for updating an access policy to said first telecommunication network transmitted by the first device,
update a data routing function implemented within said second network by means of said set of parameters for updating received.

Such a system, by establishing a direct communication between a device of a communication network MEC (first network) such as an orchestrator device, and a device of a communication network MNO (second network) implementing at least any one of NEF, PCF, SMF or UPF functions enables the implementation of a more flexible and dynamic procedure for updating the access policy to the communication network MEC. As a reminder, within the context of the present development, the term “access policy” means an access policy to the resources of the first communication network by one or more devices belonging to the second communication network.

Indeed, the parameters for updating the access policy are considered, in the present solution, as provided by a device implementing the PCF function belonging to a radio communication network of the third-party MNO type, via an interface of the N24 or N4 type depending on the function implemented by the device of the communication network MNO receiving the parameters for updating the access policy.

Such a solution makes it possible to take into account, within a satisfactory timeframe, modifications made by the operator of the communication network MEC to the access policy used to take into account latency constraints, traffic minimisation, reconfiguration of servers, content and applications on the servers, or routing security in order to optimise the routing of user devices traffic to a suitable access server of the communication network MEC.

Such a dynamic update, at the level of a device in the radio communication network MNO, of the access policy to the communication network MEC contributes to preserve the advantages specific to architectures of the “edge computing” type, particularly in terms of latency and reliability.

Thus, the routing performed by the device in the communication network MNO implementing the UPF function is performed on the basis of the updated access policy to the communication network MEC.

The development relates more particularly to a method for updating an access policy to a first telecommunication network, comprising the following steps implemented by at least one device belonging to a second telecommunication network:
receiving at least one set of parameters for updating the access policy to said first network,
updating a data routing function implemented within said second network by means of said set of parameters for updating received.

In one example, the set of parameters for updating the access policy comprises at least one parameter belonging to the group comprising:
a network address of at least one access server to the first network,
an identifier of the first network,
an address of at least one terminal of the second network,
the address of a network of the second network,
a domain name to which at least one access server to said first network belongs,
a domain or sub-domain name whose management is delegated to at least one access server to said first network,
an identifier of at least one compute node in a node cluster, said compute node belonging to the first network.

The parameters for updating the access policy may include information relating to one or more compute nodes of a node cluster such as a node cluster orchestrated by means of Kubernetes technology.

In one example, the parameters included in the at least one set of parameters for updating the access policy are selected according to rights associated with a mobile terminal attached to the second network. These parameters can also be selected according to services hosted within the first network.

It is for example characteristics of the application executed by the mobile terminal known to the first network from, for example, existing or past sessions between this mobile terminal and devices belonging to the first network.

The update is initiated, in a first example, by a redirection of an HTTPS session established between a server of the second network and a server belonging to the first network, or, in a second example, when reconnecting to a server of the first network during a redirection of the HTTPS session established between a server of the second network and a server of the first network. In a third example, sending redirection recommendations to the mobile terminal in an HTTP1 Alt-SVC header or in an HTTP2 ALTSVC message giving listing the servers of the first network (HTTP2 on 192.169.1.1:443, QUIC on 192.169.1.1:4343) that are better able to serve the requested application (e.g. Alt-SVC:h2=“mec1.example.com:8000”, h2=“192.169.1.1:443”, h3=“192.169.1.1:4343”; ma=60). These redirections are then preceded by the sending of an internal redirection signal to the first network (srv1_cloud sends srv2_MEC “I'm redirecting source ip 192.168.1.1 to 192.169.1.1 UDP port 4343 in 10 seconds”) between the servers and gateways of the first network hosting the application. The reception of this signal on the platforms of the first network initiates an update of the “access” rules between the first network and the second network based on this signal.

Thus, as an example, let an application such as a replay application, replay.télé1.fr, which has servers for broadcasting content, for example by means of streaming. These servers are located both in the second communication network (srv1.télé1.fr) and in the first communication network (srv2.télé1.fr). The server srv1.télé1.fr, located in the second communication network, receives a request to broadcast a content C1 coming from a terminal. After analysis, the server srv1.télé1.fr determines that this request should be processed by the server srv2.télé1.fr located in the first communication network because it is better placed to serve the content C1. The server srv1.télé1.fr then redirects the request to the server srv2.télé1.fr in accordance with the access policy of the first communication network.

In another example, the updating step comprises the transmission of information for updating the data routing function to another entity of the second network implementing said data routing function.

Such a method can be implemented directly within a device of the communication network MNO implementing the UPF function. In such an example, the device of the communication network MNO implementing the UPF function receives the parameters for updating the access policy and directly updates its routing table. This example is particularly interesting in the event of an urgent update of the access policy, particularly when one or more access servers are down or inaccessible, in order to guarantee continued access to a service and/or an application accessible via these access servers.

In one example, said device implements a function for coordinating the access to the transmission medium of said second network.

This example is interesting because traditionally, the device implementing the PCF function controls and coordinates the various devices in the communication network MNO implementing the SMF and UPF functions. Actually, the device implementing the PCF function can therefore broadcast the parameters for updating the access policy to a large number of devices on the communication network MNO.

In one example, said device implements a function for predicting the load of the second network.

By providing the parameters for updating the access policy to a device of the communication network MNO implementing an NWDAF (Network Data Analytic Function), it is ensured that this update is applied in compliance with the capacities of the communication network MNO, since this device implementing the NWDAF function is interested in predicting a state of the network according to current data relating to a state of the communication network MNO.

In another example, the device implements a function for exposing capacities of the second network.

Such a device implementing an NEF function is, in a known manner, subscribed to the device orchestrating the communication network MEC. Thus, the implementation of this example does not introduce any structural modifications to these two devices.

The development also relates to a method communicating between a first device in a first telecommunication network and at least one second device belonging to a second telecommunication network, said method being implemented by said first device and comprising the following steps:
generating at least one set of parameters for updating the access policy to said first network, initiated by obtaining information relating to a modification to said access policy,
transmitting, to the second device, said set of parameters for updating the access policy to said first network.

In one example, obtaining information relating to a modification of said access policy occurs at repeated time intervals.

With time intervals repeated on a regular basis, it is ensured that the communication network MNO is kept regularly informed of changes to the access policy of the communication network MEC.

The time intervals can also be repeated sporadically, if the communication network MNO is informed of changes to the access policy of the communication network MEC only when necessary, which limits exchanges between the communication network MNO and the communication network MEC.

The development further relates to a device belonging to a first telecommunication network comprising at least one processor configured to:
receive at least one set of parameters for updating an access policy to a second telecommunication network,
update a data routing function implemented within said first network by means of said set of parameters for updating received.

The development further relates to a device belonging to a first telecommunication network comprising at least one processor configured to:
generate at least one set of parameters for updating the access policy to said first network, initiated by obtaining information relating to a modification to said access policy,
transmit, to a second device belonging to a second telecommunication network, said set of parameters for updating the access policy to said first network.

The development finally relates to computer program products comprising program code instructions for implementing the methods as described previously, when they are executed by a processor.

The development also relates to a computer-readable storage medium on which are saved computer programs comprising program code instructions for implementing the steps of the methods according to the development as described above.

Such a storage medium can be any entity or device able to store the programs. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer programs contained therein can be executed remotely. The programs according to the development can be downloaded in particular on a network, for example the Internet network.

Alternatively, the storage medium can be an integrated circuit in which the programs are embedded, the circuit being adapted to execute or to be used in the execution of the above-mentioned methods that are the subject of the development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows in a simplified manner a system comprising a radio communication network interacting with an architecture of the “edge computing” type according to the prior art,

FIG. 2: this figure shows a system in which the present development is implemented,

FIG. 3: this figure shows a diagram of the various steps implemented when executing a general example of the methods that are the subject of the development,

FIG. 4: this figure shows a diagram of the various steps implemented when executing a first example of the methods that are the subject of the development,

FIG. 5: this figure shows a diagram of the various steps implemented when executing a second example of the methods that are the subject of the development,

FIG. 6: this figure shows a diagram of the various steps implemented when executing a third example of the methods that are the subject of the development,

FIG. 7: this figure shows a device belonging to the communication network MNO capable of implementing the various methods that are the subject of the present development,

FIG. 8: this figure shows a device belonging to the communication network MEC capable of implementing the various methods that are the subject of the present development.

### DETAILED DESCRIPTION OF CERTAIN ILLUSTRATIVE EMBODIMENTS

The general principle of the development is based on the establishment of a direct communication between a device of a first communication network implemented in the form of an “edge computing” architecture, such as an orchestrator device, and a device of a second radio communication network implementing at least any one of the NEF, PCF, SMF or UPF functions within this radio communication network. The establishment of such a direct communication enables the implementation of a flexible and dynamic procedure for updating the access policy to the first communication network MEC.

Such a solution then makes it possible to take into account, within a satisfactory timeframe, modifications made by the operator of the first communication network to the access policy used to take into account latency constraints, traffic minimisation, servers, content and applications on the servers, or routing security in order to optimise the routing of user devices traffic to a suitable access server of the first suitable communication network.

Thus, the routing performed by the device implementing the UPF function within the second communication network is performed on the basis of the updated access policy to the first communication network.

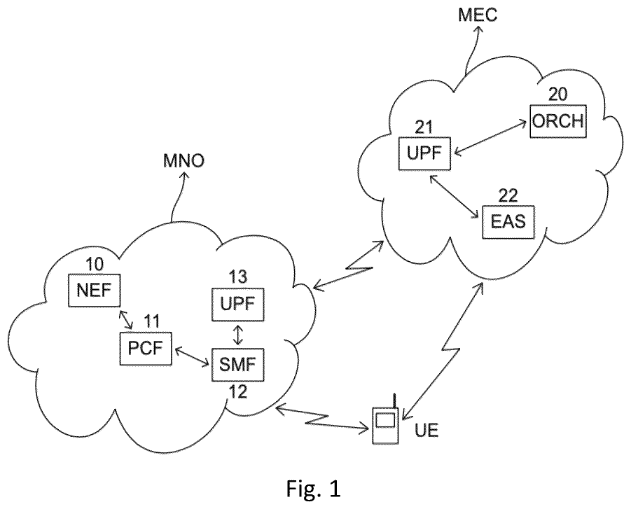

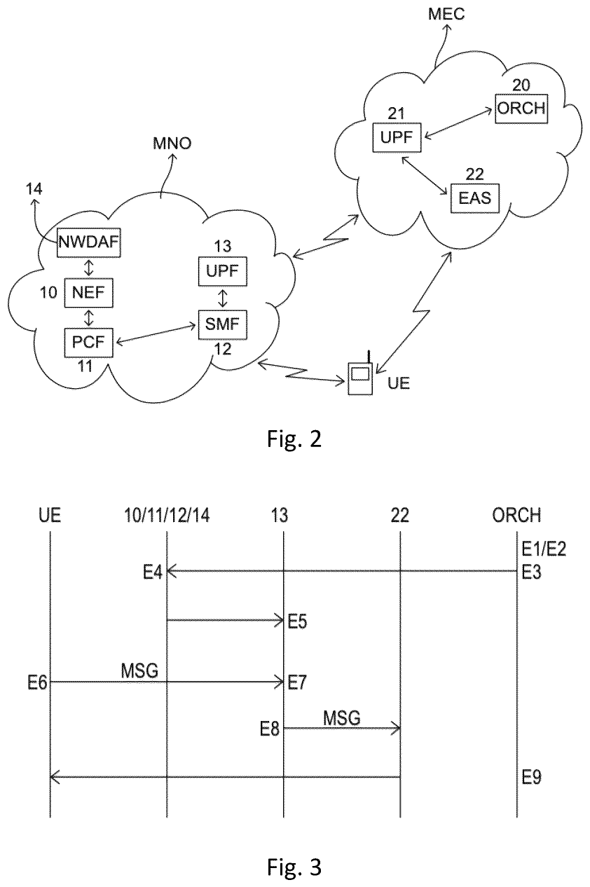

In relation to FIG. 2, a system in which the present solution is implemented is now presented. The elements already described in FIG. 1 are identified by the same references.

A radio communication network MNO operated by a telecommunication operator comprises a plurality of devices 10-14 such as servers implementing various functions relating to the attachment and connectivity of user devices UE exchanging data via the infrastructures of the radio communication network MNO. In the example described, the radio communication network MNO complies with fifth generation or 5G telecommunications standards. Of course, such a communication network MNO may comply with other generations of telecommunications standards.

In the example described, a first device 10 implements a Network Exposure Function (NEF), a second device 11 implements a Policy Control Function (PCF), a third device 12 implements a Session Management Function (SMF) and at least a fourth device 13 implements a User Plane Function (UPF). The radio communication network MNO also includes a device 14 implementing a load prediction function or NWDAF (Network Data Analytic Function).

This radio communication network MNO interacts with a second communication network MEC (Multi-access Edge Computing) implemented in the form of an “edge computing” architecture.

Such a communication network MEC comprises a plurality of devices 20-22 such as servers implementing various functions enabling user devices UE exchanging data via the infrastructures of the radio communication network MNO to access services and/or applications hosted in the communication network MEC. In the example described, the radio communication network MEC also complies with fifth generation or 5G telecommunications standards. Of course, such a communication network MEC may comply with other generations of telecommunications standards.

In the example described, a first device 20 implements a function for orchestrating the communication network MEC, at least a second device 21 implements a data routing function or UPF (User Plane Function) and at least a third device 22 is a server for accessing a service and/or an application.

In such a system, the routing of the streams conforming to the PDP (Packet Data Protocol) within the communication network MNO is carried out according to the access policy defined by the operator of the communication network MNO.

The parameters allowing the implementation of this access policy are transmitted by the device 12 implementing the SMF function to the device 13 implementing the UPF function, which implements this access policy according to the parameters received. The device 12 has itself received information about the access policy to be implemented from the device 11 implementing the PCF function.

Similarly, the routing, within the communication network MNO, of data streams destined for the access server 22 belonging to the communication network MEC is carried according to an access policy defined by the operator of the communication network MEC.

The present solution teaches a method for updating the access policy to the communication network MEC making it possible to inform the devices of the communication network MNO concerned of the new conditions for redirecting streams from a user device UE attached to the radio communication network MNO to the MEC radio communication network.

With reference to the system described in FIG. 2, a general example of the methods that are the subject of the development is now described. The various steps implemented when executing these methods within the system previously described are shown in the form of a diagram in FIG. 3.

Thus, in a step E1, the orchestrator 20 obtains information relating to a modification of the access policy to the communication network MEC. This information is, for example, sent to the orchestrator 20 in one or more messages. In another example, the orchestrator 20 uses a URL identifying a server from which it can download information relating to the modification of the access policy. In another example, the information relating to the modification of the access policy can be transmitted to the orchestrator 20 in “push” mode in the form of an update file to be implemented.

Then, in a step E2, the orchestrator 20 generates a set of parameters for updating the access policy PMaj according to the information relating to the modification of the access policy obtained during step E1.

Such update parameters PMaj may consist, among other things, of:
a network address of at least one access server 22,
an identifier of the communication network MEC,
a domain name to which at least one access server 22 belongs,
an identifier of a server capable of resolving domain names,
an identifier of at least one compute node of a Kubernetes node cluster contributing to the implementation of a service and/or a given application, said compute node belonging to the communication network MEC,
etc.

The parameters included in the at least one set of update parameters PMaj can be selected according to rights associated with each user device UE attached to the second network. It is then possible to obtain sets of update parameters PMaj specific to a user device UE. These parameters can also be selected according to services hosted within the communication network MEC.

Once the set of parameters for updating the access policy PMaj has been generated, the orchestrator 22 broadcasts this set of parameters to at least one device 10-14 belonging to the radio communication network MNO, in a step E3. Depending on the nature of the device 10-14 receiving the set of parameters for updating the access policy PMaj, the set of parameters for updating the access policy PMaj is received via an interface of the N24 or N4 type as defined in the documents ETSI TS 123 501 V15.2.0 (2018-06) 5G; and “System Architecture for the 5G System” (3GPP TS 23.501 version 15.2.0 Release 15).

In a step E4, a device 10-14 belonging to the radio communication network MNO receives the set of parameters for updating the access policy PMaj.

Finally, in a step E5, a routing table of the device 13 implementing the UPF function is updated by means of the set of parameters for updating the access policy PMaj.

In the case where the device in the communication network MNO which has received the set of update parameters PMaj is not the device 13 implementing the UPF function but any one of the devices 10, 11, 12 or 14, step E5 is preceded by the transmission of the set of update parameters PMaj to the device 13 implementing the UPF function.

When a user device attached to the communication network MNO wants to access an accessible service and/or application hosted in the communication network MEC, the user device UE transmits a message MSG requesting access to the service and/or application in question through the communication network MNO in a step E6.

The message MSG is then intercepted by the device 13 implementing the UPF function which, by consulting its routing table during a step E7, identifies the access server 22 belonging to the communication network MEC to which the message MSG must be transmitted in a step E8.

Upon reception of the message MSG, the access server 22 of the communication network MEC transmits, in a step E9, an acknowledgement message to the user device UE.

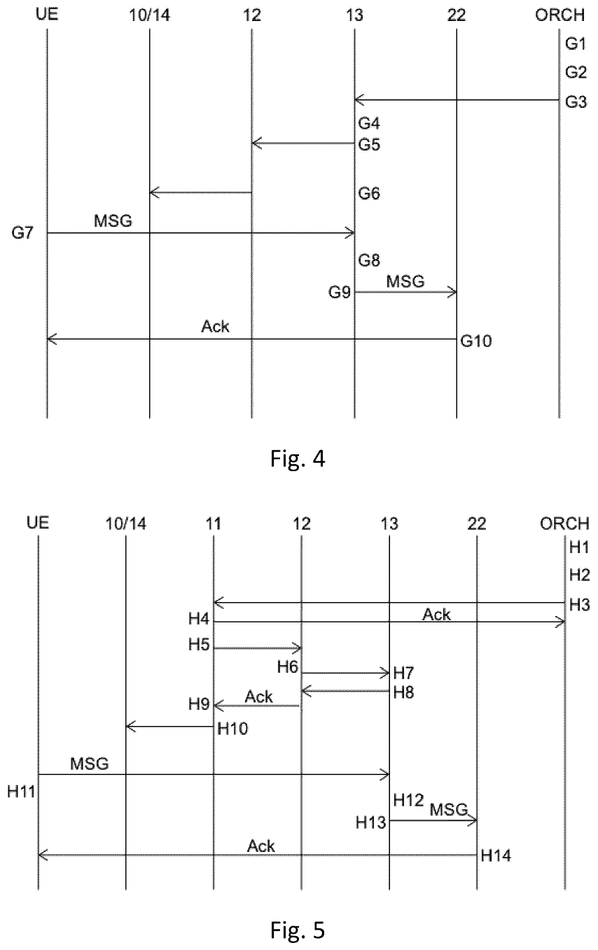

A first example of the methods that are the subject of the development is now described. The various steps implemented when executing these methods within the system previously described are shown in the form of a diagram in FIG. 4.

Thus, in a step G1, the orchestrator 20 obtains information relating to a modification of the access policy to the communication network MEC. This information is, for example, sent to the orchestrator 20 in one or more messages. In another example, the orchestrator 20 uses a URL identifying a server from which it can download information relating to the modification of the access policy. In another example, the information relating to the modification of the access policy can be transmitted to the orchestrator 20 in “push” mode in the form of an update file to be implemented.

Then, in a step G2, the orchestrator 20 generates a set of parameters for updating the access policy PMaj according to the information relating to the modification of the access policy obtained during step G1.

Once the set of parameters for updating the access policy PMaj has been generated, the orchestrator 20 broadcasts this set of parameters to at least one device 13 implementing the UPF function belonging to the radio communication network MNO, in a step G3.

Finally, in a step G4, the device 13 implementing the UPF function updates its routing table by means of the set of parameters for updating the access policy PMaj.

This first example is particularly interesting in the event of an urgent update of the access policy of the communication network MEC, particularly when one or more access servers 22 are down or inaccessible, in order to guarantee continued access to a service and/or an application accessible via these access servers 22.

In a step G5, the device 13 implementing the UPF function informs the device 12 implementing the SFM function that its routing table has been updated. Optionally, the device 12 implementing the SMF function can broadcast this information to other devices in the communication network MNO implementing the UPF function, which can in turn update their routing table.

The device 12 implementing the SFM function also informs, in a step G6, the devices 10 and 14 implementing the NEF and NWDAF functions of the modification of the routing policy of the communication network MEC. Indeed, the devices 10 and 14 implementing the NEF and NWDAF functions are the central devices for managing data traffic within the communication network MNO.

When a user device attached to the communication network MNO wants to access an accessible service and/or application hosted in the communication network MEC, the user device UE transmits a message MSG requesting access to the service and/or application in question through the communication network MNO in a step G7.

The message MSG is then intercepted by the device 13 implementing the UPF function which, by consulting its routing table during a step G8, identifies the access server 22 belonging to the communication network MEC to which the message MSG must be transmitted in a step G9.

Upon reception of the message MSG, the access server 22 of the communication network MEC transmits, in a step G10, an acknowledgement message to the user device UE.

A second example of the methods that are the subject of the development is now described. The various steps implemented when executing these methods within the system previously described are shown in the form of a diagram in FIG. 5.

Thus, in a step H1, the orchestrator 20 obtains information relating to a modification of the access policy to the communication network MEC. This information is, for example, sent to the orchestrator 20 in one or more messages. In another example, the orchestrator 20 uses a URL identifying a server from which it can download information relating to the modification of the access policy. In another example, the information relating to the modification of the access policy can be transmitted to the orchestrator 20 in “push” mode in the form of an update file to be implemented.

Then, in a step H2, the orchestrator 20 generates a set of parameters for updating the access policy PMaj according to the information relating to the modification of the access policy obtained during step H1.

Once the set of parameters for updating the access policy PMaj has been generated, the orchestrator 20 broadcasts this set of parameters to at least one device 11 implementing the PCF function belonging to the radio communication network MNO, in a step H3. The set of parameters for updating the access policy PMaj is received by the device implementing the PCF function 11 via an interface of the N24 type.

In a step H4, the device implementing the PCF function 11 acknowledges reception of the set of parameters for updating the access policy PMaj to the orchestrator 20.

The device 11 implementing the PCF function transmits, in a step H5 which may be simultaneous with the implementation of step H4, a message informing the device 12 implementing the SMF function of the occurrence of an update of the access policy to the communication network MEC. Such a message also includes the set of parameters for updating the access policy PMaj.

Following the reception of the set of parameters for updating the access policy PMaj, the device 12 implementing the SMF function transmits this set of parameters for updating the access policy PMaj to the device 13 implementing the UPF function, during a step H6.

In a step H7, the device 13 implementing the UPF function updates its routing table by means of the set of parameters for updating the access policy PMaj.

In a step H8, the device 13 implementing the UPF function informs the device 12 implementing the SFM function that its routing table has been updated.

Upon reception of the update information sent by the device 13 implementing the UPF function, the device implementing the SMF function 12 acknowledges the update of the access policy PMaj to the device implementing the PCF function 11 in a step H9.

The device implementing the PCF function 11 also informs, in a step H10, the devices 10 and 14 implementing the NEF and NWDAF functions of the modification of the routing policy of the communication network MEC. Indeed, the devices 10 and 14 implementing the NEF and NWDAF functions are the central devices for managing data traffic within the communication network MNO.

When a user device attached to the communication network MNO wants to access an accessible service and/or application hosted in the communication network MEC, the user device UE transmits a message MSG requesting access to the service and/or application in question through the communication network MNO in a step H11.

The message MSG is then intercepted by the device 13 implementing the UPF function which, by consulting its routing table during a step H12, identifies the access server 22 belonging to the communication network MEC to which the message MSG must be transmitted in a step H13.

Upon reception of the message MSG, the access server 22 of the communication network MEC transmits, in a step H14, an acknowledgement message to the user device UE.

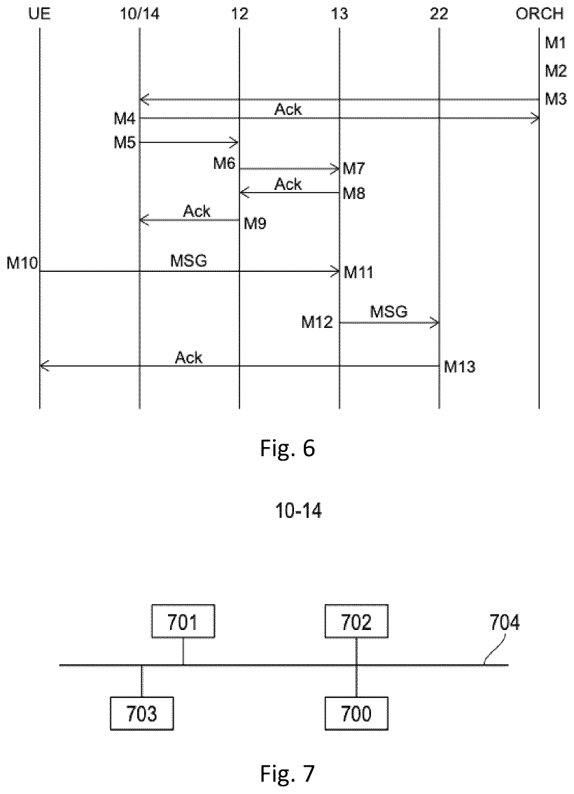

A third example of the methods that are the subject of the development is finally described. The various steps implemented when executing these methods within the system previously described are shown in the form of a diagram in FIG. 6.

Thus, in a step M1, the orchestrator 20 obtains information relating to a modification of the access policy to the communication network MEC. This information is, for example, sent to the orchestrator 20 in one or more messages. In another example, the orchestrator 20 uses a URL identifying a server from which it can download information relating to the modification of the access policy. In another example, the information relating to the modification of the access policy can be transmitted to the orchestrator 20 in “push” mode in the form of an update file to be implemented.

Then, in a step M2, the orchestrator 20 generates a set of parameters for updating the access policy PMaj according to the information relating to the modification of the access policy obtained during step M1.

Once the set of parameters for updating the access policy PMaj has been generated, the orchestrator 22 broadcasts this set of parameters to the device 10 implementing the NEF function belonging to the radio communication network MNO, in a step M3. Optionally, the device 10 implementing the NEF function updates the device 14 implementing the NWDAF function with the received set of parameters for updating the access policy PMaj.

In a step M4, the device 10 implementing the NEF function acknowledges reception of the set of parameters for updating the access policy PMaj to the orchestrator 20.

The device 10 implementing the NEF function transmits, in a step M5 which may be simultaneous with the implementation of step M4, a message informing the device 12 implementing the SMF function of the occurrence of an update of the access policy to the communication network MEC. Such a message also includes the set of parameters for updating the access policy PMaj. In an example not shown in FIG. 6, the step M5 may be implemented by the device 14 implementing the NWDAF function.

Following the reception of the set of parameters for updating the access policy PMaj, the device 12 implementing the SMF function transmits this set of parameters for updating the access policy PMaj to the device 13 implementing the UPF function, during a step M6.

In a step M7, the device 13 implementing the UPF function updates its routing table by means of the set of parameters for updating the access policy PMaj.

In a step M8, the device 13 implementing the UPF function informs the device 12 implementing the SFM function that its routing table has been updated.

Upon reception of the update information sent by the device 13 implementing the UPF function, the device implementing the SMF function 12 acknowledges the update of the access policy PMaj to the device implementing the NEF function 10 in a step M9.

In an example not shown in FIG. 6, the device implementing the SMF function 12 acknowledges the update of the access policy PMaj to the device implementing the PCF function.

In this last example, the device implementing the PCF function 11 in turn informs the device 10 implementing the NEF function of the modification of the routing policy of the communication network MEC.

When a user device attached to the communication network MNO wants to access an accessible service and/or application hosted in the communication network MEC, the user device UE transmits a message MSG requesting access to the service and/or application in question through the communication network MNO in a step M10.

The message MSG is then intercepted by the device 13 implementing the UPF function which, by consulting its routing table during a step M11, identifies the access server 22 belonging to the communication network MEC to which the message MSG must be transmitted in a step M12.

Upon reception of the message MSG, the access server 22 of the communication network MEC transmits, in a step M13, an acknowledgement message to the user device UE.

FIG. 7 shows a device 10-14 belonging to the communication network MNO capable of implementing the various methods that are the subject of the present development.

A device 10-14 may comprise at least one hardware processor 700, a storage unit 701, a first interface 702, and at least one second interface 703 which are connected to each other via a bus 704. Naturally, the components of the device 10-14 can be connected by means of a connection other than a bus.

The processor 700 controls the operations of the device 10-14. The storage unit 701 stores at least one program for implementing the various methods that are the subject of the development to be executed by the processor 700, and various data, such as parameters used for calculations performed by the processor 700, intermediate data for calculations performed by the processor 700, etc. The processor 800 may be formed by any known and appropriate hardware or software, or by a combination of hardware and software. For example, the processor 700 can be formed by a dedicated hardware such as a processing circuit, or by a programmable processing unit such as a Central Processing Unit which executes a program stored in a memory thereof.

The storage unit 701 may be formed by any appropriate means capable of storing the program or programs and data in a computer-readable manner. Examples of storage units 701 include non-transitory computer-readable storage media such as semiconductor memory devices, and magnetic, optical or magneto-optical recording media loaded into a read/write device.

The interface 702 provides an interface between a device 10-14 and at least one other device 10-14 belonging to the communication network MNO or a device 20-22 belonging to the communication network MEC.

As for the network interface 703, it provides a connection between a device 10-14 and a user device UE.

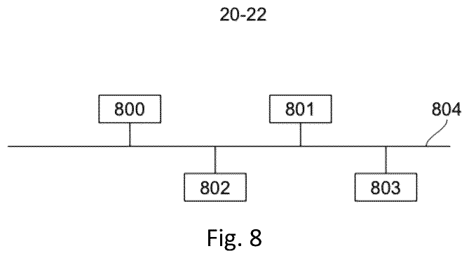

FIG. 8 shows a device 20-22 belonging to the communication network MEC capable of implementing the various methods that are the subject of the present development.

A device 20-22 may comprise at least one hardware processor 800, a storage unit 801, a first interface 802, and at least one second interface 803 which are connected to each other via a bus 804. Naturally, the components of the device 20-22 can be connected by means of a connection other than a bus.

The processor 800 controls the operations of the device 20-22. The storage unit 801 stores at least one program for implementing the various methods that are the subject of the development to be executed by the processor 800, and various data, such as parameters used for calculations performed by the processor 800, intermediate data for calculations performed by the processor 800, etc. The processor 800 may be formed by any known and appropriate hardware or software, or by a combination of hardware and software. For example, the processor 800 can be formed by a dedicated hardware such as a processing circuit, or by a programmable processing unit such as a Central Processing Unit which executes a program stored in a memory thereof.

The storage unit 801 may be formed by any appropriate means capable of storing the program or programs and data in a computer-readable manner. Examples of storage units 801 include non-transitory computer-readable storage media such as semiconductor memory devices, and magnetic, optical or magneto-optical recording media loaded into a read/write device.

The interface 802 provides an interface between a device 20-22 and at least one other device 20-22 belonging to the communication network MEC or a device 10-14 belonging to the communication network MNO.

As for the network interface 803, it provides a connection between a device 20-22 and a user device UE.

1. A system comprising at least one first device belonging to a first telecommunication network and at least one second device belonging to a second telecommunication network, wherein the first device comprises at least one processor configured to:
generate at least one set of parameters for updating an access policy to the first network, initiated by obtaining information relating to a modification to the access policy,
transmit the set of parameters for updating the access policy to the first network to the second device, and wherein the second device comprises at least one processor configured to:
receive the set of parameters for updating an access policy to the first telecommunication network transmitted by the first device, and
update a data routing function implemented within the second network by means of the set of parameters for updating received.

2. A method for updating an access policy to a first telecommunication network, comprising the following acts implemented by at least one device belonging to a second telecommunication network:
receiving at least one set of parameters for updating the access policy to the first network, and
updating a data routing function implemented within the second network by means of the set of parameters for updating received.

3. The method for updating an access policy according to claim 2, wherein the set of parameters for updating the access policy comprises at least one parameter belonging to a group comprising:
a network address of at least one access server to the first network,
an address of at least one terminal of the second network,
the address of a network of the second network,
an identifier of the first network,
a domain or sub-domain name whose management is delegated to at least one access server to the first network,
a domain name to which at least one access server to the first network belongs, and
an identifier of at least one compute node in a node cluster, the compute node belonging to the first network.

4. The method for updating an access policy according to claim 3, wherein the parameters included in the at least one set of parameters for updating the access policy are selected according to rights associated with a mobile terminal attached to the second network.

5. The method for updating an access policy according to claim 3, wherein the parameters included in the at least one set of parameters for updating the access policy are selected according to services hosted within the first network.

6. The method for updating an access policy according to claim 2, wherein the updating comprises the transmission of information for updating the data routing function to another entity of the second network implementing the data routing function.

7. The method for updating an access policy according to claim 6, wherein the device implements a function for coordinating the access to the transmission medium of the second network.

8. The method for updating an access policy according to claim 6, wherein the device implements a function for predicting the load of the second network.

9. The method for updating an access policy according to claim 6, wherein the device implements a function for exposing the capacities of the second network.

10. A method of communicating between a first device of a first telecommunication network and at least one second device belonging to a second telecommunication network, the method being implemented by the first device and comprising the following:
generating at least one set of parameters for updating the access policy to the first network, initiated by obtaining information relating to a modification to the access policy, and
transmitting, to the second device, the set of parameters for updating the access policy to the first network.

11. The method of communicating between a first device in a first telecommunication network and at least one second device belonging to a second telecommunication network according to claim 10, wherein obtaining information relating to a modification of the access policy occurs at repeated time intervals.

12. A device belonging to a first telecommunication network comprising at least one processor configured to:
receive at least one set of parameters for updating an access policy to a second telecommunication network, and
update a data routing function implemented within the first network by means of the set of parameters for updating received.

13. A device belonging to a first telecommunication network comprising at least one processor configured to:
generate at least one set of parameters for updating the access policy to the first network, initiated by obtaining information relating to a modification to the access policy, and
transmit, to a second device belonging to a second telecommunication network, the set of parameters for updating the access policy to the first network.

14. A processing circuit comprising a processor and a memory, the memory storing program code instructions of a computer program to execute the method according to claim 1, when the computer program is executed by the processor.

15. A processing circuit comprising a processor and a memory, the memory storing program code instructions of a computer program to execute the method according to claim 10, when the computer program is executed by the processor.
